(19) United States
(12) Patent Application Publication
(10) Pub. No.: US 2026/0319455 A1
(43) Pub. Date: Oct. 15, 2026

(54) NUMERICAL CONTROL DEVICE AND NUMERICAL CONTROL PROGRAM

(71) Applicant: FANUC CORPORATION, Yamanashi (JP)

(72) Inventor: Daiki KIKKAWA, Yamanashi (JP)

(73) Assignee: FANUC CORPORATION, Yamanashi (JP)

(21) Appl. No.: 19/481,039

(22) PCT Filed: Jun. 28, 2023
(86) PCT No.: PCT/JP2023/023963

§ 371 Date: Nov. 3, 2025

(51) Int. Cl. G05B 19/4061; G05B 19/404

(52) U.S. Cl. CPC G05B 19/4061; G05B 19/404; G05B 2219/37237

(57) ABSTRACT

Provided is a numerical control device (1) capable of determining whether or not a processing nozzle (62) interferes with a workpiece (5). The numerical control device (1) includes: an interpolation processing unit (22) that performs interpolation on the basis of a processing program; a groove angle calculation unit (23) that calculates the groove angle from the position of a rotation axis obtained by the interpolation processing unit (22); and a groove-correction-amount calculation unit (24) that calculates a groove correction amount by which correction is made in the processing nozzle direction from at least a predetermined distance from the workpiece designated by the program and the groove angle. The numerical control device (1) includes: a processing nozzle-position calculation unit (30) that calculates a position at which the processing nozzle (62) can interfere with the workpiece from the shape of the processing nozzle (62) set in advance and the groove angle; and an interference determination unit (31) that determines whether the processing nozzle (62) and the workpiece (5) interfere with each other, from the predetermined distance and the processing nozzle position. The interference determination unit (31) determines whether the processing nozzle (62) and the workpiece (5) interfere with each other during groove machining, on the basis of the predetermined distance and the processing nozzle position.

### TECHNICAL FIELD

The present disclosure relates to a numerical control device for controlling a machine tool.

### BACKGROUND ART

Some machine tools perform laser machining on a machining surface of a workpiece by irradiating the machining surface with a laser from a machining nozzle. When performing bevel cutting with such a machine tool, the machining nozzle is inclined with respect to the machining surface of the workpiece. Patent Document 1 discloses a technique of irradiating laser light while inclining a nozzle.

With reference to FIG. 1, an inclination of a conventional machining nozzle 60 when performing bevel cutting will be described. FIG. 1 shows a state in which the conventional machining nozzle 60 is inclined. The machining nozzle 60 is attached to a nozzle body 50. As shown in FIG. 1, when inclining the machining nozzle 60, the machining nozzle 60 is normally inclined while keeping a distance 120 between a tip center 64 of the machining nozzle 60 and a machining point 12 of a machining surface 10 of a workpiece 5 constant. Hereinafter, the distance 120 is referred to as a machining point distance 120.

A machining nozzle 601 shown in FIG. 1 is the machining nozzle 60 that is not inclined. A machining nozzle 602 is the machining nozzle 60 that is inclined. An arrow 130 is a line indicating the path of the inclination of the machining nozzle 60. The machining point distance 120 with respect to the machining nozzle 601 and the machining point distance 120 with respect to the machining nozzle 602 are the same distance.

As indicated by the arrow 130, when the machining nozzle 60 is inclined while keeping the machining point distance 120 constant, a distance 122 between the tip center 64 of the machining nozzle 60 and the machining surface 10 of the workpiece 5 becomes shorter. Hereinafter, the distance 122 is referred to as a machining surface distance 122. When the machining surface distance 122 becomes shorter, the machining nozzle 60 may approach the workpiece 5, and the machining nozzle 60 may come into contact with the workpiece 5.

Therefore, a technique has been proposed to reduce the risk of the inclined machining nozzle 60 coming into contact with the workpiece 5. For example, there has been proposed a technique of inclining the machining nozzle 60 while keeping the machining surface distance 122 constant instead of the machining point distance 120 when performing bevel cutting.

A line 106 indicates the position of the tip center 64 when keeping the machining surface distance 122 constant. Hereinafter, the line 106 is referred to as a G reference line 106. The distance between the machining surface 10 and the G reference line 106 is referred to as a gap amount G.

A machining nozzle 603 shown in FIG. 1 is the machining nozzle 60 that is inclined while keeping the machining surface distance 122 constant. An arrow 132 in FIG. 1 indicates the path of the machining nozzle 60 when inclined while keeping the machining surface distance 122 constant.

The distance between the tip center 64 of the machining nozzle 602 inclined while keeping the machining point distance 120 constant and the tip center 64 of the machining nozzle 603 inclined while keeping the machining surface distance 122 constant is referred to as a bevel correction amount 124. The position of the machining nozzle 603 inclined while keeping the machining surface distance 122 constant is a position obtained by moving the machining nozzle 602 inclined while keeping the machining point distance 120 constant by the bevel correction amount 124 in the direction of a nozzle central axis 104.

### CITATION LIST

### Patent Document

Patent Document 1: Japanese Unexamined Patent Application, Publication No. 2002-011587

### DISCLOSURE OF THE INVENTION

### Problems to be Solved by the Invention

In the above-described technique, when performing bevel cutting, the machining nozzle 60 is inclined while keeping the machining surface distance 122 constant. Therefore, when the gap amount G is small or when the machining nozzle 60 is large, the machining nozzle 60 may come into contact with the workpiece 5.

FIG. 2 shows a state in which the machining nozzle 60 comes into contact with the workpiece 5. The machining nozzle 601 of FIG. 2 represents the machining nozzle 60 that is not inclined. The machining nozzle 603 represents the machining nozzle 60 that is inclined. The machining nozzle 603 is inclined while keeping the machining surface distance 122 constant.

A portion of the machining nozzle 60 closest to the machining surface 10 is referred to as a closest portion 66. As shown in FIG. 2, the closest portion 66 of the inclined machining nozzle 603 is in contact with the machining surface 10 of the workpiece 5. The portion where the closest portion 66 contacts the machining surface 10 is indicated by an arrow 134. As shown in FIG. 2, in a conventional technique, there are cases where the machining nozzle comes into contact with the workpiece, that is, where the machining nozzle interferes with the workpiece.

Accordingly, an object of the present disclosure is to provide a numerical control device capable of determining whether a machining nozzle and a workpiece will interfere with each other.

### Means for Solving the Problems

A numerical control device of the present disclosure includes: an interpolation processing unit configured to perform interpolation based on a machining program; a bevel angle calculation unit configured to calculate a bevel angle from a rotational axis position determined by the interpolation processing unit; and a bevel correction amount calculation unit configured to calculate a bevel correction amount by which correction is made in a machining nozzle direction from at least a constant distance from a workpiece specified by the program and the bevel angle. The numerical control device further includes: a machining nozzle position calculation unit configured to calculate a position of a machining nozzle that has potential to interfere with the workpiece from a preset shape of the machining nozzle and the bevel angle; and an interference determination unit configured to determine whether the machining nozzle and the workpiece will interfere with each other from the constant distance and the position of the machining nozzle. The interference determination unit determines whether the machining nozzle and the workpiece will interfere with each other during bevel cutting based on the constant distance and the position of the machining nozzle.

According to the numerical control device of the present disclosure, it is possible to provide the numerical control device capable of determining whether the machining nozzle and the workpiece will interfere with each other.

A numerical control program of the present disclosure causes a computer to function as a numerical control device. The numerical control device includes: an interpolation processing unit configured to perform interpolation based on a machining program; a bevel angle calculation unit configured to calculate a bevel angle from a rotational axis position determined by the interpolation processing unit; and a bevel correction amount calculation unit configured to calculate a bevel correction amount by which correction is made in a machining nozzle direction from at least a constant distance from a workpiece specified by the program and the bevel angle. The numerical control program causes the computer to further function as: a machining nozzle position calculation unit configured to calculate a position of a machining nozzle that has potential to interfere with the workpiece from a preset shape of the machining nozzle and the bevel angle; and an interference determination unit configured to determine whether the machining nozzle and the workpiece will interfere with each other from the constant distance and the position of the machining nozzle. The interference determination unit determines whether the machining nozzle and the workpiece will interfere with each other during bevel cutting based on the constant distance and the position of the machining nozzle.

According to the numerical control program of the present disclosure, it is possible to cause the computer to function as the numerical control device of the present disclosure. Accordingly, similarly to the numerical control device of the present disclosure, it is possible to determine whether the machining nozzle and the workpiece will interfere with each other.

### BRIEF DESCRIPTION OF THE DRAWINGS

FIG. 1 shows a conventional technique and a state in which a machining nozzle is inclined;

FIG. 2 shows an inclined machining nozzle;

FIG. 3 shows an outline of a machine tool;

FIG. 4 shows an outline of a numerical control device according to the present embodiment;

FIG. 5 showing a modification of the numerical control device;

FIG. 6 shows the machining nozzle at an interference nozzle position and the machining nozzle at an interference avoidance nozzle position;

FIG. 7 is a flowchart showing the process flow of the numerical control device;

FIG. 8 is a diagram for explaining a method of calculating a shape correction amount;

FIG. 9 shows each vertex of the machining nozzle;

FIG. 10 shows the machining nozzle inclined according to a bevel angle; and

FIG. 11 is a table showing a bevel angle and a distance H at the bevel angle.

### PREFERRED MODE FOR CARRYING OUT THE INVENTION

An embodiment of the present disclosure will be described with reference to the drawings. Note that the present disclosure is not limited to the following embodiment. The present disclosure can be implemented with modifications as appropriate without departing from the spirit of the present disclosure.

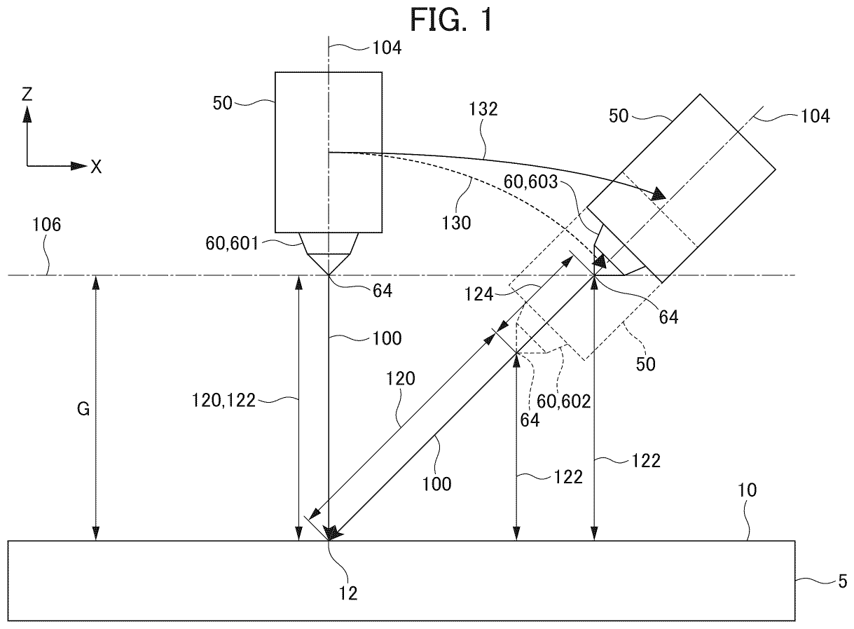

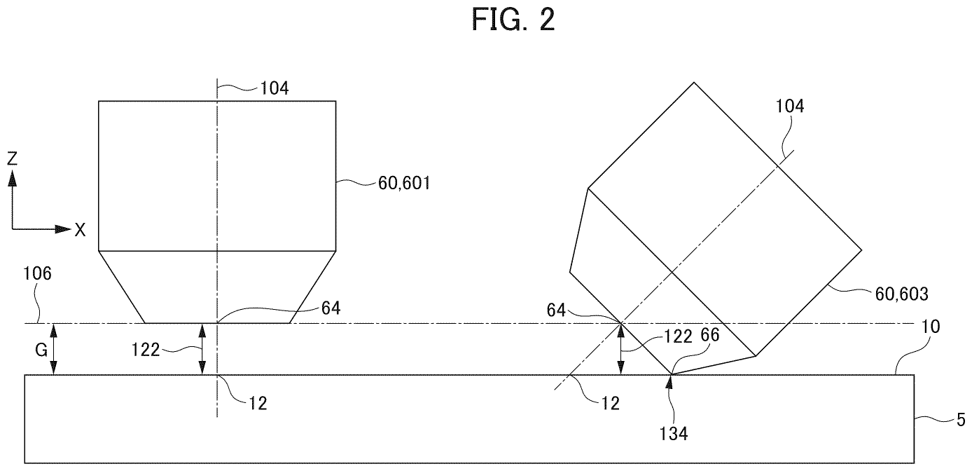

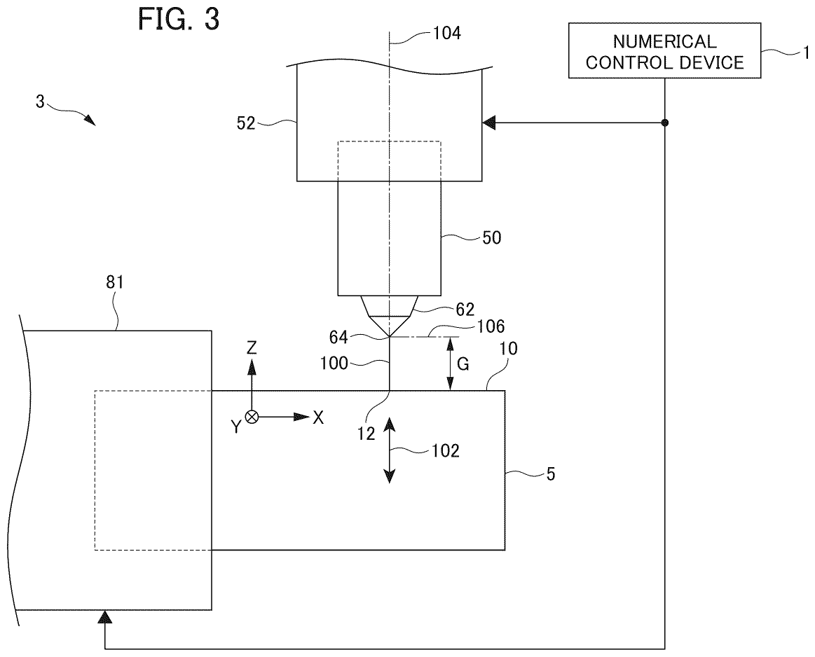

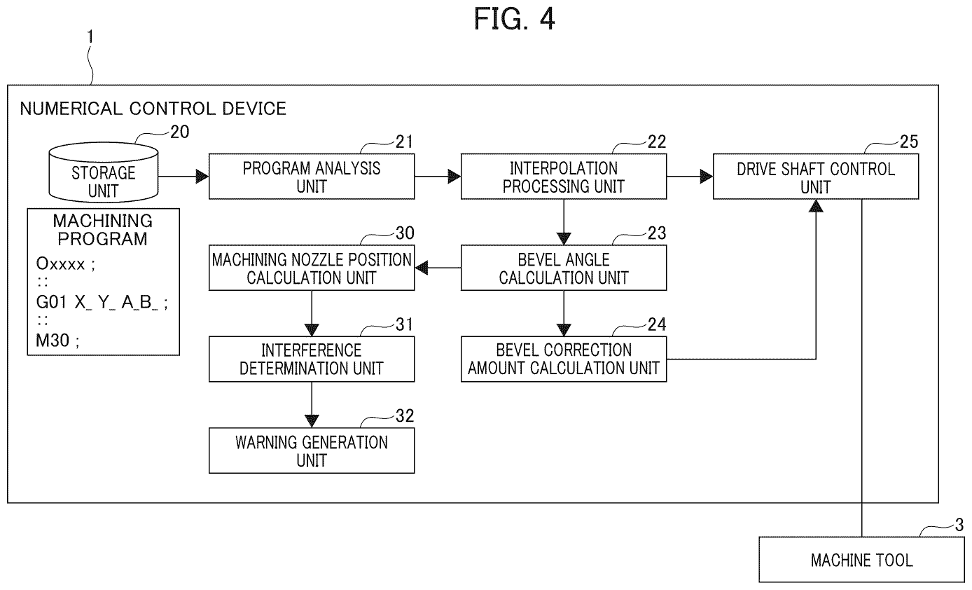

With reference to FIGS. 3 and 4, the configuration of a numerical control device 1 of the present embodiment will be described. Note that descriptions of matters similar to those described with reference to FIGS. 1 and 2 will be omitted. FIG. 3 shows an outline of a machine tool 3. FIG. 4 shows an outline of the numerical control device 1 of the present embodiment. The numerical control device 1 controls the machine tool 3 according to a command based on numerical information.

Hereinafter, three directions orthogonal to each other are referred to as an X direction, a Y direction, and a Z direction. The X direction and the Y direction are directions parallel to a machining surface 10 of a workpiece 5. The Z direction is a direction perpendicular to the machining surface 10.

The machine tool 3 includes a nozzle holding part 52 and a workpiece holding part 7. The nozzle holding part 52 is a part that holds a machining nozzle 62. The workpiece holding part 7 is a part that holds the workpiece 5. The numerical control device 1 can relatively move the machining nozzle 62 and the workpiece 5 by moving at least one of the nozzle holding part 52 and the workpiece holding part 7.

The relative movement includes at least one of an X-direction relative movement, a Y-direction relative movement, a Z-direction relative movement, a relative rotational movement about the X direction, a relative rotational movement about the Y direction, and a relative rotational movement about the Z direction. The relative movement may be performed by moving the machining nozzle 62. Alternatively, it may be performed by moving the workpiece 5. Alternatively, it may be performed by moving both the machining nozzle 62 and the workpiece 5.

In the following description, a case where the workpiece 5 does not move and the machining nozzle 62 moves will be described. However, if the relative positional relationship between the machining nozzle 62 and the workpiece 5 is the same, either the machining nozzle 62 or the workpiece 5 may be moved.

The machine tool 3 irradiates the workpiece 5 with a laser 100 from the machining nozzle 62. The machine tool 3 performs laser machining by the irradiation of the laser 100. Hereinafter, a direction in which the machining nozzle 62 irradiates the laser 100 is referred to as an irradiation direction 102.

The numerical control device 1 will be described. The numerical control device 1 is a device that controls the machine tool 3. The numerical control device 1 is connected to the machine tool 3. The numerical control device 1 is configured to allow a user or the like to input a machining program. The numerical control device 1 controls the machine tool 3 based on an input machining program.

The numerical control device 1 includes a storage unit 20, a program analysis unit 21, an interpolation processing unit 22, and a drive shaft control unit 25. The storage unit 20 is a part that stores a machining program input by a user or the like. The program analysis unit 21 is a part that analyzes the machining program. The program analysis unit 21 is connected to the storage unit 20. The interpolation processing unit 22 is a part that performs interpolation based on a result analyzed by the program analysis unit 21. The interpolation processing unit 22 determines the rotational axis position of the machining nozzle 62. The interpolation processing unit 22 is connected to the program analysis unit 21.

The numerical control device 1 further includes a bevel angle calculation unit 23 and a bevel correction amount calculation unit 24. Each of the bevel angle calculation unit 23 and the bevel correction amount calculation unit 24 is a part that performs processing related to bevel cutting. The bevel angle calculation unit 23 calculates a bevel angle from the rotational axis position determined by the interpolation processing unit 22. The bevel correction amount calculation unit 24 calculates the bevel correction amount 124 from at least the gap amount G specified by the machining program and the bevel angle calculated by the bevel angle calculation unit 23. The bevel correction amount 124 is a correction amount when the machining nozzle 62 is corrected in the direction of a nozzle central axis 104. The direction of the nozzle central axis 104 may be referred to as a machining nozzle direction.

The drive shaft control unit 25 is a part that controls the drive of the nozzle holding part 52 and the workpiece holding part 7. The drive shaft control unit 25 is connected to the interpolation processing unit 22 and the bevel correction amount calculation unit 24. The drive shaft control unit 25 controls the drive of at least one of the nozzle holding part 52 and the workpiece holding part 7 based on the result of interpolation performed by the interpolation processing unit 22 and the bevel correction amount 124 calculated by the bevel correction amount calculation unit 24. For example, when performing bevel cutting, the drive shaft control unit 25 inclines the machining nozzle 62 in accordance with the bevel angle and moves the machining nozzle 62 in the direction of the nozzle central axis 104 by the bevel correction amount 124.

The numerical control device 1 according to the present disclosure further includes a machining nozzle position calculation unit 30 and an interference determination unit 31. Each of the machining nozzle position calculation unit 30 and the interference determination unit 31 is a part that performs processing related to interference between the machining nozzle 62 and the workpiece 5. The position of the machining nozzle 62 at which the machining nozzle 62 and the workpiece 5 may interfere with each other is referred to as an interference nozzle position. The machining nozzle position calculation unit 30 is a part that calculates the interference nozzle position. The machining nozzle position calculation unit 30 calculates the interference nozzle position based on the preset shape of the machining nozzle 62 and the bevel angle calculated by the bevel angle calculation unit 23.

The interference determination unit 31 is a part that determines whether the machining nozzle 62 and the workpiece 5 will interfere with each other. The interference determination unit 31 determines whether the machining nozzle 62 and the workpiece 5 will interfere with each other based on the gap amount G and the interference nozzle position.

In the numerical control device 1 of the present embodiment, the machining nozzle position calculation unit 30 calculates the position of the machining nozzle 62 that may interfere with the workpiece 5, i.e., the interference nozzle position from the preset shape of the machining nozzle 62 and the bevel angle determined by the bevel angle calculation unit 23. The interference determination unit 31 determines whether the machining nozzle 62 and the workpiece will interfere with each other based on at least a constant distance from the workpiece 5 specified by the machining program, i.e., the gap amount G, and the interference nozzle position. As described above, the numerical control device 1 of the present embodiment can determine whether the machining nozzle 62 and the workpiece 5 will interfere with each other by calculating the position of the machining nozzle 62 that may interfere with the workpiece 5.

### Modification 1

Modification 1 of the numerical control device 1 will be described. As shown in FIG. 4, the numerical control device 1 may include a warning generation unit 32. The warning generation unit 32 is a part that generates a warning when the machining nozzle 62 and the workpiece are likely to interfere with each other. The warning generation unit 32 is connected to the interference determination unit 31. The warning generation unit 32 generates a warning when the interference determination unit 31 determines that the machining nozzle 62 and the workpiece will interfere with each other. Examples of the warning generated by the warning generation unit 32 include a warning sound, a warning by light, and a warning display. The warning generation unit 32 generates a warning in a case where it is determined that the machining nozzle 62 will interfere with the workpiece, thereby enabling the inclination of the machining nozzle 62 to be stopped before interference occurs.

### Modification 2

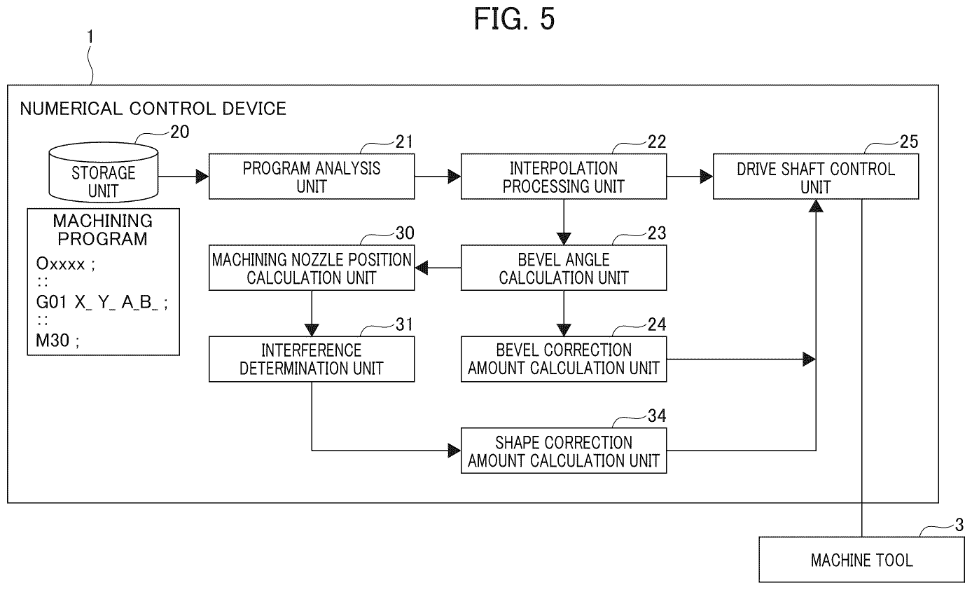

Modification 2 of the numerical control device 1 will be described. FIG. 5 shows Modification 2 of the numerical control device 1. As shown in FIG. 5, the numerical control device 1 may include a shape correction amount calculation unit 34. The shape correction amount calculation unit 34 is a part that calculates a shape correction amount from the position of the machining nozzle 62 at which the machining nozzle 62 and the workpiece 5 may interfere with each other, i.e., the interference nozzle position, and the bevel angle. Here, the position of the machining nozzle 62 when a closest portion 66 of the machining nozzle 62 is located on the G reference line 106 is referred to as an interference avoidance nozzle position. The shape correction amount refers to a movement amount when the machining nozzle 62 is moved from the interference nozzle position to the interference avoidance nozzle position along the nozzle central axis 104.

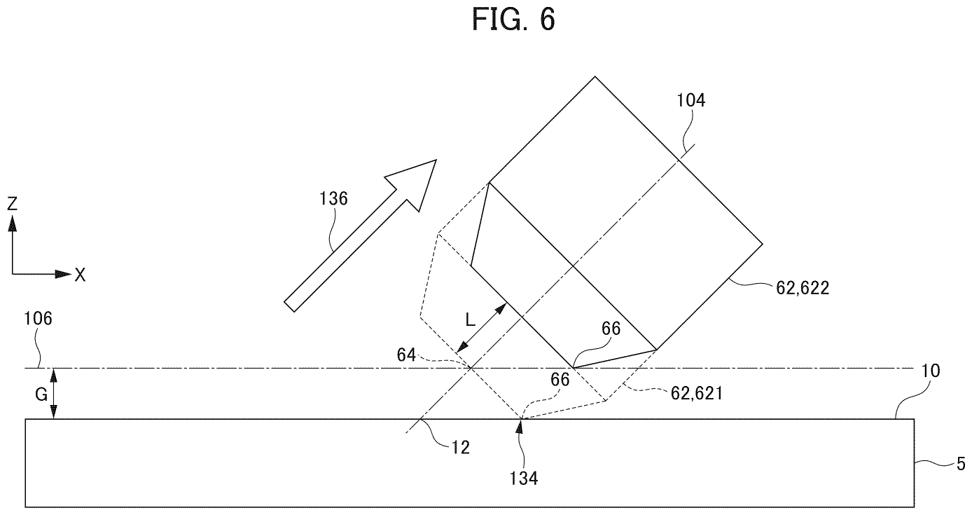

With reference to FIG. 6, the shape correction amount will be described. FIG. 6 shows the machining nozzle 62 at the interference nozzle position and the machining nozzle 62 at the interference avoidance nozzle position. A machining nozzle 621 shown in FIG. 6 is the machining nozzle 62 at the interference nozzle position. The closest portion 66 of the machining nozzle 621 contacts the machining surface 10 of the workpiece 5 as indicated by an arrow 134.

A machining nozzle 622 shown in FIG. 6 is the machining nozzle 62 at the interference avoidance nozzle position. The closest portion 66 of the machining nozzle 622 is located on the G reference line 106.

The machining nozzle 622 at the interference avoidance nozzle position is obtained by moving the machining nozzle 621 at the interference nozzle position by a distance L in a direction indicated by an arrow 136 along the nozzle central axis 104. The distance L is a shape correction amount L.

As shown in FIG. 5, the shape correction amount calculation unit 34 is connected to the interference determination unit 31. When the interference determination unit 31 determines that the machining nozzle 62 and the workpiece will interfere with each other, the shape correction amount calculation unit 34 calculates the shape correction amount L.

The shape correction amount calculation unit 34 is connected to the drive shaft control unit 25. The shape correction amount calculation unit 34 transmits the calculated shape correction amount L to the drive shaft control unit 25. The drive shaft control unit 25 controls the machine tool 3 so that the machining nozzle 62 moves based on the shape correction amount L. Accordingly, when the machining nozzle 62 and the workpiece 5 are likely to interfere with each other, the shaft of the machining nozzle 62 can be controlled to be driven in the direction of the nozzle central axis 104 so that the machining nozzle 62 and the workpiece 5 do not interfere with each other. The movement amount of the machining nozzle 62 may be equal to or greater than the shape correction amount L.

As described above, the shape correction amount calculation unit 34 calculates the correction amount in the case of correcting the position of the machining nozzle 62 that may interfere with the workpiece 5 in the direction of the nozzle central axis 104 so as not to interfere with the workpiece 5, based on the shape of the machining nozzle 62 set in advance. As a result, when the machining nozzle 62 and the workpiece 5 are likely to interfere with each other, the interference can be avoided without stopping the machining. Also in Modification 2, the numerical control device 1 may include the warning generation unit 32 as in Modification 1.

As the preset shape of the machining nozzle 62, various aspects of the shape, such as the radius of the tip of the machining nozzle 62, the outer dimensions of the machining nozzle 62, and the coordinates of each vertex of the machining nozzle 62 described later, can be set as necessary.

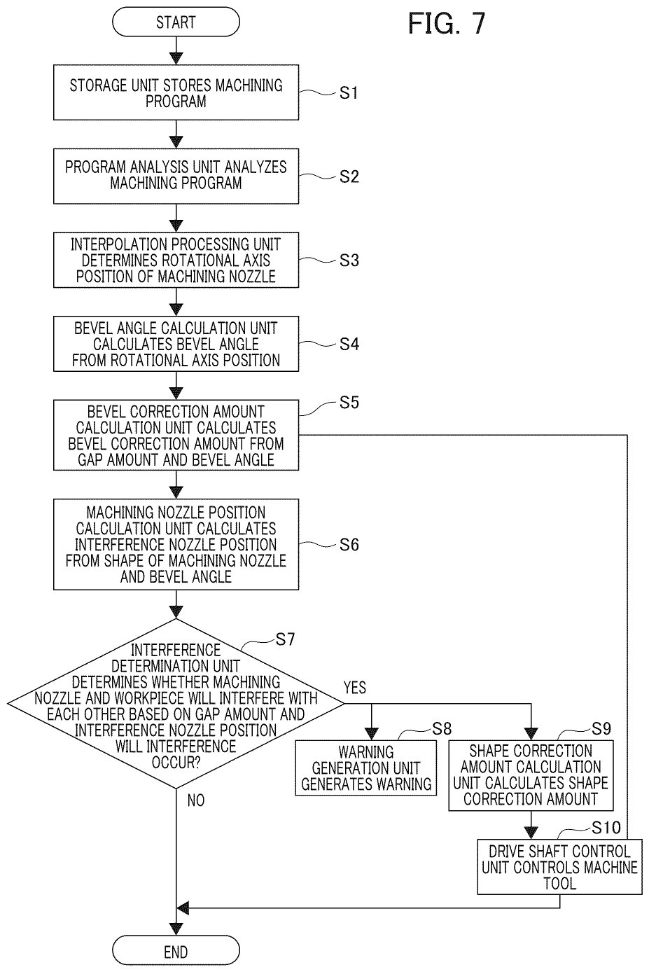

With reference to FIG. 7, an example of the process flow of the numerical control device 1 will be described. FIG. 7 is a flowchart showing the process flow of the numerical control device 1. Note that the process flow shown in FIG. 7 is an example. The process flow can be variously changed according to the configuration of the numerical control device 1, the method of each calculation, and the like. In FIG. 7 and the following description, S1 denotes Step 1. The same applies to S2 and subsequent steps.

In S1, the storage unit 20 stores a machining program input by a user or the like. In S2, the program analysis unit 21 analyzes the machining program. In S3, the interpolation processing unit 22 determines the rotational axis position of the machining nozzle 62 based on the analysis result in S2. In S4, the bevel angle calculation unit 23 calculates the bevel angle based on the rotational axis position determined in S3. In S5, the bevel correction amount calculation unit 24 calculates the bevel correction amount 124 based on the gap amount G and the bevel angle calculated in S4. The calculated bevel correction amount 124 is transmitted to the drive shaft control unit 25. In S6, the machining nozzle position calculation unit 30 calculates the interference nozzle position based on the shape of the machining nozzle 62 and the bevel angle calculated in S4. In S7, the interference determination unit 31 determines whether the machining nozzle 62 and the workpiece 5 will interfere with each other based on the gap amount G and the interference nozzle position calculated in S6. If it is determined that there will be no interference, the flow ends. If it is determined that interference will occur, the flow advances to at least one of S8 and S9. In S8, the warning generation unit 32 generates a warning. In S9, the shape correction amount calculation unit 34 calculates the shape correction amount L. The calculated shape correction amount L is transmitted to the drive shaft control unit 25. In S10, the drive shaft control unit 25 controls the machine tool 3 according to the bevel correction amount 124 calculated in S5 and the shape correction amount L calculated in S9. As a result, the machining nozzle 62 is disposed at an appropriate position. Then, the flow ends.

### First Determination and Calculation Method

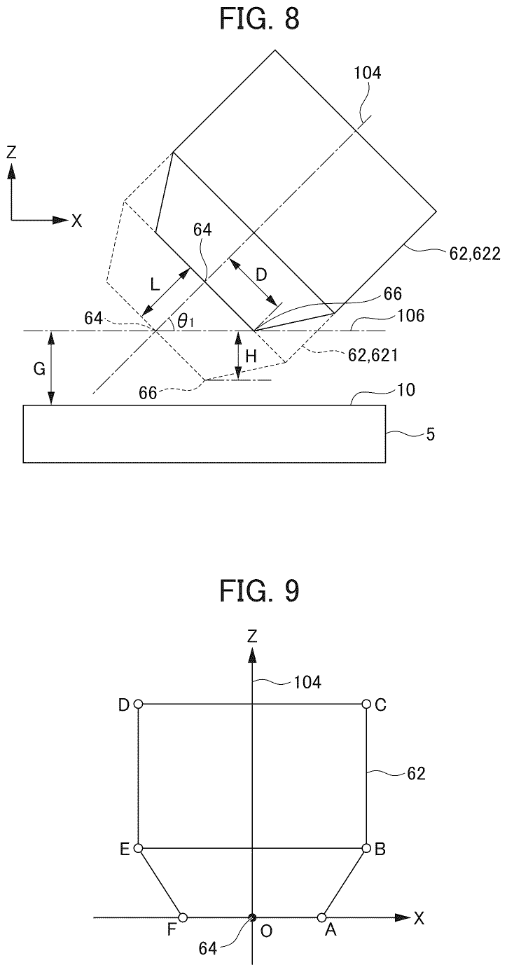

A method of determining whether the machining nozzle 62 and the workpiece will interfere with each other and a method of calculating the shape correction amount L will be described. With reference to FIG. 8, a first method will be described. FIG. 8 shows a positional relationship between the machining nozzle 62 and the workpiece 5 in order to explain a method of calculating the shape correction amount L and the like. The tip center 64 of the machining nozzle 621 shown in FIG. 8 is located at the G reference line 106. The closest portion 66 of the machining nozzle 622 is located on the G reference line 106. That is, the machining nozzle 622 is located at the interference avoidance nozzle position.

In FIG. 8, a distance D is the radius of the tip of the machining nozzle 62. A distance H is the distance between the closest portion 66 of the machining nozzle 62 and the G reference line 106. In FIG. 8, the distance H is the distance between the closest portion 66 of the machining nozzle 62 and the tip center 64 in a direction perpendicular to the machining surface 10 of the workpiece 5, i.e., in the Z direction. G is the gap amount G. L is the shape correction amount L. When the distance H is equal to or greater than the gap amount G, the machining nozzle 62 and the workpiece 5 interfere with each other.

The gap amount G is a predetermined constant distance. Whether the machining nozzle 62 and the workpiece 5 interfere with each other is determined by the distance H. The distance H is calculated according to the following equation when the bevel angle is (90°−θ₁). H=D*cosθ₁

The interference determination unit 31 calculates the distance H using the above equation. Then, it is determined whether the machining nozzle 62 and the workpiece 5 will interfere with each other by comparing the distance H with the gap amount G.

A method of calculating the shape correction amount L will be described. A movement amount when the position of the machining nozzle 62 where the machining nozzle 62 and the workpiece 5 may interfere with each other is retracted to a position where the interference can be avoided is the shape correction amount L. Specifically, the machining nozzle 62 is retracted to a position where the closest portion 66 of the machining nozzle 62 is located on the G reference line 106, i.e., to the interference avoidance nozzle position. The shape correction amount L is calculated according to the following equation. L=H/sinθ₁

The above equation may be modified to the following equation. L=D/tanθ₁

When the interference determination unit 31 determines that the machining nozzle 62 and the workpiece will interfere with each other, the shape correction amount calculation unit 34 calculates the shape correction amount L based on the above equation.

### Second Determination and Calculation Method

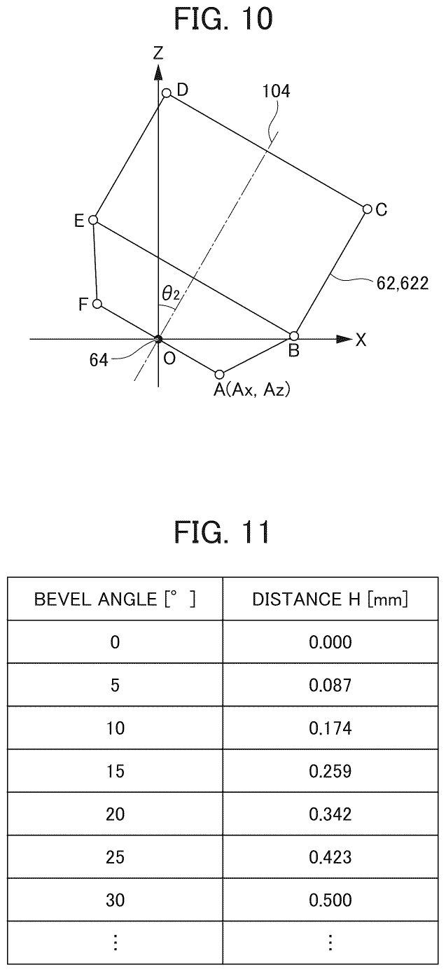

Next, a second method will be described with reference to FIGS. 9 and 10. FIG. 9 shows each vertex of the machining nozzle 62 in the XZ plane. FIG. 10 shows the machining nozzle 62 inclined according to the bevel angle θ₂.

In the first method, the distance H used to determine whether the machining nozzle 62 and the workpiece 5 will interfere with each other is determined by focusing on the closest portion 66 of a nozzle body 50. In the second method, the distance H is determined based on the vertex most likely to interfere with the workpiece 5 among the vertices of the machining nozzle 62. Therefore, in the second method, it is possible to accurately determine whether the machining nozzle 62 and the workpiece 5 will interfere with each other with respect to more various movements of the machining nozzle 62. Hereinafter, description will be given.

When the shape of the machining nozzle 62 is specified by setting a plurality of vertices, the positions of the vertices can be set by XZ coordinates, for example, as shown in FIG. 9. The origin is the tip center 64 of the machining nozzle 62. In the example shown in FIG. 9, the shape of the machining nozzle 62 is specified by using six points A to F as vertices.

FIG. 10 shows the machining nozzle 60 inclined when performing bevel cutting. When performing bevel cutting, the machining nozzle 60 is inclined. This inclination is considered as rotation about the origin, i.e., the tip center 64. Each vertex of the machining nozzle 62 is rotated about the tip center 64 according to the bevel angle θ₂.

In this case, for example, the position (Ax′, Az′) obtained by rotating vertex A (Ax, Az) by the bevel angle θ₂ is calculated according to the following equations. Ax′=Ax*cos (−θ₂)−Az*sin (−θ₂)

$$Az = Rx * sin ( - {θ}_{2} ) + Az ⋆ cos ( - {θ}_{2} )$$

The coordinates of the positions of the other vertices after the rotation can be determined using the same equations.

Based on the coordinates of the vertices after the rotation determined in this manner, the vertex most likely to interfere with the workpiece 5 is selected from the vertices. For example, it is assumed that the vertex is vertex A. In this case, the distance H, which is the distance between vertex A most likely to interfere with the workpiece, among the vertices, and the G reference line 106, is calculated according to the following equation. H=|0−Az′|

After the distance H is determined in this manner, the determination of interference and the calculation of the shape correction amount L are performed in the same manner as in the first method.

### Third Determination and Calculation Method

Next, a third method will be described with reference to FIG. 11. FIG. 11 is a table showing a bevel angle and a distance H at the bevel angle. In the third method, the position of the machining nozzle 62 that may interfere with the workpiece 5 at each bevel angle is set in the table, and the shape of the machining nozzle 62 is specified.

For each bevel angle, a distance H corresponding to a portion of the machining nozzle 62 that may interfere with the workpiece 5 is prepared in advance as a table. That is, the distance H, which is the distance between the position of the machining nozzle 62 that may interfere with the workpiece 5 corresponding to the bevel angle and the G reference line 106, is set in the table.

When performing bevel cutting, the distance H corresponding to the bevel angle is acquired from the table. When the bevel angle is not listed in the table, the corresponding distance H is calculated based on the values listed in the table. For example, when the bevel angle is 18°, the distance H is calculated according to the following equation. H=0.259+ (18−15)*((0.342−0.259)/(20−15)) That is, the change ratio of the distance H with respect to the change of the bevel angle is determined from the distances H corresponding to the bevel angles before and after changing to the target bevel angle. Then, the distance H corresponding to the target bevel angle is determined based on the change ratio.

After determining the distance H in this manner, the determination of interference and the calculation of the shape correction amount L are performed in the same manner as in the first method.

Each function of the numerical control device 1 may be realized by a combination of hardware and software. Alternatively, each function may be realized only by hardware. Here, the hardware means, for example, an electronic circuit.

A case where each function of the numerical control device 1 is realized by software will be described. Hereinafter, the numerical control device 1 is simply referred to as a device. The functions of the device can be realized by a program for causing a computer to function as a device, the program being for causing the computer to function as each unit of the device.

In this case, the device includes, as hardware for executing the program, a computer including at least one control device and at least one storage device. An example of the control device is a processor. An example of the storage device is a memory. The functions described in the embodiment are realized by executing the program by the control device and the storage device.

The program may be recorded on one or more computer-readable recording media rather than temporarily. The recording medium may be included in the device. Alternatively, the recording medium may be provided in a part other than the device. In the latter case, the program may be provided to the device via any wired or wireless transmission medium.

At least a part of the function of each unit may be realized by a logic circuit. For example, an integrated circuit in which a logic circuit functioning as each unit is formed is included in the present disclosure.

As described above, the numerical control device 1 can be configured mainly by, for example, a computer and a numerical control program. The computer includes a CPU, a RAM, a ROM, and the like. The numerical control program is a program that, in cooperation with a computer, causes the computer to function as a numerical control device. The numerical control device 1 of the present embodiment can be implemented using the computer.

Note that the present disclosure is not limited to the above-described embodiment and modifications, and modifications and improvements within a range in which the object of the present disclosure can be achieved are included in the present disclosure.

The following additional remarks are further disclosed with respect to the above-described embodiment and modifications.

### Additional Remark 1

A numerical control device (1) includes: an interpolation processing unit (22) configured to perform interpolation based on a machining program; a bevel angle calculation unit (23) configured to calculate a bevel angle from a rotational axis position determined by the interpolation processing unit (22); and a bevel correction amount calculation unit (24) configured to calculate a bevel correction amount by which correction is made in a machining nozzle direction from at least a constant distance from a workpiece specified by the program and the bevel angle. The numerical control device (1) further includes: a machining nozzle position calculation unit (30) configured to calculate a position of a machining nozzle (62) that has potential to interfere with the workpiece from a preset shape of the machining nozzle (62) and the bevel angle; and an interference determination unit (31) configured to determine whether the machining nozzle (62) and the workpiece (5) will interfere with each other from the constant distance and the position of the machining nozzle. The interference determination unit (31) determines whether the machining nozzle (62) and the workpiece (5) will interfere with each other during bevel cutting based on the constant distance and the position of the machining nozzle.

### Additional Remark 2

In the above numerical control device (1), a warning is generated in a case where it is determined that the machining nozzle (62) and the workpiece (5) will interfere with each other.

### Additional Remark 3

The above numerical control device (1) includes a shape correction amount calculation unit (34) configured to calculate a shape correction amount by which correction is made in the machining nozzle direction from the position of the machining nozzle and the bevel angle. In a case where it is determined that the machining nozzle (62) and the workpiece (5) will interfere with each other, a shaft is controlled to be driven by the shape correction amount or more in the machining nozzle direction so that the machining nozzle (62) and the workpiece (5) do not interfere with each other.

### Additional Remark 4

A numerical control program causes a computer to function as a numerical control device (1). The numerical control device (1) includes: an interpolation processing unit (22) configured to perform interpolation based on a machining program; a bevel angle calculation unit (23) configured to calculate a bevel angle from a rotational axis position determined by the interpolation processing unit (22); and a bevel correction amount calculation unit (24) configured to calculate a bevel correction amount by which correction is made in a machining nozzle direction from at least a constant distance from a workpiece specified by the program and the bevel angle.

The numerical control program causes the computer to further function as:
a machining nozzle position calculation unit (30) configured to calculate a position of a machining nozzle that has potential to interfere with the workpiece from a preset shape of the machining nozzle and the bevel angle; and an interference determination unit (31) configured to determine whether the machining nozzle (62) and the workpiece (5) will interfere with each other from the constant distance and the position of the machining nozzle. The interference determination unit (31) determines whether the machining nozzle (62) and the workpiece (5) will interfere with each other during bevel cutting based on the constant distance and the position of the machining nozzle.

### EXPLANATION OF REFERENCE NUMERALS

1 numerical control device
5 workpiece
22 interpolation processing unit
23 bevel angle calculation unit
24 bevel correction amount calculation unit
30 machining nozzle position calculation unit
31 interference determination unit
62 machining nozzle

1. A numerical control device comprising: an interpolation processing unit configured to perform interpolation based on a machining program; a bevel angle calculation unit configured to calculate a bevel angle from a rotational axis position determined by the interpolation processing unit; and a bevel correction amount calculation unit configured to calculate a bevel correction amount by which correction is made in a machining nozzle direction from at least a constant distance from a workpiece specified by the program and the bevel angle,
the numerical control device further comprising: a machining nozzle position calculation unit configured to calculate a position of a machining nozzle that has potential to interfere with the workpiece from a preset shape of the machining nozzle and the bevel angle; and an interference determination unit configured to determine whether the machining nozzle and the workpiece will interfere with each other from the constant distance and the position of the machining nozzle,
wherein the interference determination unit determines whether the machining nozzle and the workpiece will interfere with each other during bevel cutting based on the constant distance and the position of the machining nozzle.

2. The numerical control device according to claim 1, wherein a warning is generated in a case where it is determined that the machining nozzle and the workpiece will interfere with each other.

3. The numerical control device according to claim 1, comprising a shape correction amount calculation unit configured to calculate a shape correction amount by which correction is made in the machining nozzle direction from the position of the machining nozzle and the bevel angle,
wherein in a case where it is determined that the machining nozzle and the workpiece will interfere with each other, a shaft is controlled to be driven by the shape correction amount or more in the machining nozzle direction so that the machining nozzle and the workpiece do not interfere with each other.

4. A non-transitory computer-readable medium storing a numerical control program comprising instructions for causing a computer to function as a numerical control device, the numerical control device comprising: an interpolation processing unit configured to perform interpolation based on a machining program; a bevel angle calculation unit configured to calculate a bevel angle from a rotational axis position determined by the interpolation processing unit; and a bevel correction amount calculation unit configured to calculate a bevel correction amount by which correction is made in a machining nozzle direction from at least a constant distance from a workpiece specified by the program and the bevel angle,
the instructions for causing the computer to further function as:
a machining nozzle position calculation unit configured to calculate a position of a machining nozzle that has potential to interfere with the workpiece from a preset shape of the machining nozzle and the bevel angle; and
an interference determination unit configured to determine whether the machining nozzle and the workpiece will interfere with each other from the constant distance and the position of the machining nozzle, wherein the interference determination unit determines whether the machining nozzle and the workpiece will interfere with each other during bevel cutting based on the constant distance and the position of the machining nozzle.
